(19) United States
(12) Patent Application Publication
(10) Pub. No.: US 2025/0274037 A1
(43) Pub. Date: Aug. 28, 2025

(54) CIRCUIT ARRANGEMENT FOR REDUCING DEAD TIME LOSSES OF AN INVERTER AND ELECTRICAL SYSTEM

(71) Applicant: Robert Bosch GmbH, Stuttgart (DE)

(72) Inventors: Fabian Stamer, Pforzheim (DE); Federico Carraro, Leonberg (DE)

(21) Appl. No.: 19/054,327

(22) Filed: Feb. 14, 2025

(30) Foreign Application Priority Data
Feb. 22, 2024 (DE) 10 2024 201 634.9

(51) Int. Cl. H02M 1/38; H02M 1/00; H02M 7/537

(52) U.S. Cl. CPC H02M 1/385; H02M 1/0054; H02M 7/537

(57) ABSTRACT

A circuit arrangement for reducing dead time losses of an inverter and an electrical system. The circuit arrangement includes: a half-bridge arrangement including first and second switches; a load; a control unit; and a driver unit. The first switch is a junction field effect transistor. The half-bridge arrangement is for connection to a DC voltage source and provides an AC voltage to the load using complementary control of the first and second switches by the control unit based on a voltage of the DC voltage source. The control unit is configured to maintain a dead time between the complementary switching of the first and second switch. The driver unit is configured, based on a control by the control unit, to provide a gate of the first switch with a dead time voltage during a switch-on process and/or during a switch-off process of the first switch during the dead time.

### FIELD

The present invention relates to a circuit arrangement for reducing dead time losses of an inverter and to an electrical system having such a circuit arrangement.

### BACKGROUND INFORMATION

To control n-channel self-conducting junction field effect transistors (JFETs), a gate driver that provides two different voltage levels for switching the field effect transistors on and off is usually used.

A conventional gate driver has two output states, is typically controlled by a control signal having two logic levels, and provides between the gate and source terminals of the JFET transistor a voltage of 0 V or a slightly positive voltage to switch the transistor on or a negative voltage to switch the transistor off.

When JFET transistors are used as switches in a voltage-supplied pulse-controlled inverter having an inductive load and alternating current direction, it is necessary to prevent a simultaneous on state in the respective JFET transistors of a half-bridge in order to avoid an intermediate-circuit short circuit. The alternating direction of the load current leads to a periodically repeated use of the JFET transistors in the 3rd quadrant in which the JFET transistors undergo reverse conduction.

Safe operation of such a pulse-controlled inverter having an inductive load is ensured by ensuring a dead time (or blanking time) between the respective switch-on phases of the JFET transistors.

During the dead time, both JFET transistors within a half bridge are switched off and load currents flow through an existing freewheeling path of the upper or lower JFET transistors of this half bridge, depending on the current direction.

G. Kampitsis, P. Stefas, N. Chrysogelos, S. Papathanassiou and S. Manias, “Assessment of the reverse operational characteristics of SiC JFETs in a diode-less inverter,” IECON 2013—39th Annual Conference of the IEEE Industrial Electronics Society, 2013, pp. 477-482, doi: doi.org/10.1109/IECON.2013.6699182, describes a 3-phase, 2-level half-bridge-based circuit topology (referred to as “B6 topology”) based on an implementation with JFET transistors.

### SUMMARY

According to a first aspect of the present invention, a circuit arrangement for reducing dead time losses of an inverter, in particular a voltage-supplied pulse-controlled inverter, is provided. According to an example embodiment of the present invention, the circuit arrangement has a half-bridge arrangement consisting of a first switch and a second switch; a load; a control unit; and a driver unit, wherein at least the first switch is designed as a junction field effect transistor (JFET).

The load is connected to a center point of the half-bridge arrangement and is at least partially and preferably predominantly an inductive load. The half-bridge arrangement is configured to be connected to a DC voltage source, which can be designed, for example, as an intermediate circuit capacitor, and to provide an AC voltage to the load by means of a complementary control of the first switch and the second switch by the control unit on the basis of a voltage of the DC voltage source.

It should be noted that the first switch can be used as the “low-side” switch of the half-bridge arrangement (i.e., as a switch that is connected closer to the low potential of the DC voltage source) or as the “high-side” switch of the half-bridge arrangement (i.e., as a switch that is connected closer to the high potential of the DC voltage source), while the second switch occupies the other arrangement position within the half-bridge.

The control unit is configured to maintain a dead time between the complementary switching of the first switch and the second switch in order to prevent a short circuit of the DC voltage source via simultaneously switched on switches. The control unit is, for example, designed as an ASIC, FPGA, processor, digital signal processor, microcontroller, or the like.

The driver unit is configured, on the basis of a control by the control unit, to provide a gate of the first switch with a dead time voltage (i.e., a voltage that is applied at least partially during the dead time of the first switch) during a switch-on process and/or during a switch-off process of the first switch during the dead time, which dead time voltage is less than a threshold voltage of the first switch and greater than a voltage provided for blocking the first switch outside the dead time. Therefore, when using a JFET, the dead time voltage must be a more negative voltage than the negative threshold voltage of the JFET in order to keep the first switch in a switched-off state during the dead time.

The control according to the present invention of the gate of the first switch offers the particular advantage that dead time losses can be reduced by using the dead time voltage during respective switching operations, since a voltage drop at the first switch in the 3rd quadrant (reverse operation) can be reduced by increasing the gate voltage due to the electrical properties of junction transistors. This makes it possible, for example, to reduce the chip area of the first switch due to the associated lower load on the first switch, which can, for example, save costs.

Preferred developments of the present invention are disclosed herein.

Further preferably, according to an example embodiment of the present invention, the dead time voltage is a voltage that is below the threshold voltage of the first switch while maintaining a required predefined tolerance as close as possible to the threshold voltage of the first switch. By keeping the dead time voltage as close as possible to the threshold voltage, particularly low dead time losses can be achieved. By taking into account the tolerance when determining the dead time voltage, it can be ensured that the first switch is safely in the off state.

Particularly preferably, according to an example embodiment of the present invention, the dead time voltage is between −11.5 V and −19.5 V, preferably between −12 V and −18 V and particularly preferably between −13 V and −15 V, without thereby imposing a restriction on these voltage ranges.

Further preferably, according to an example embodiment of the present invention, the second switch is also designed as a junction field effect transistor, while the circuit arrangement is configured to control the second switch during the dead time in a manner corresponding to the control of the first switch.

In an advantageous embodiment of the present invention, the circuit arrangement is configured to dynamically adapt the dead time voltage depending on present boundary conditions. In this way, for example, temperature influences and/or a value of a switched current and/or an intermediate circuit voltage and/or a gate voltage and/or a gate current and/or a junction temperature of respective switches, etc. can be taken into account when determining a suitable dead time voltage in each case, so that despite changed boundary conditions, for example, the lowest possible dead time voltage can be set in order to achieve the lowest possible dead time losses in each case.

In a further advantageous embodiment of the present invention, the circuit arrangement is configured to dynamically adapt a point in time and/or a duration of a provision of the dead time voltage within the dead time depending on present boundary conditions (e.g., those mentioned above). In other words, it is not necessary for the dead time voltage to be applied during the entire dead time. Instead, advantages according to the present invention can also be achieved if the dead time voltage is only applied in a partial phase of the dead time.

Advantageously, according to an example embodiment of the present invention, it is also possible that the driver unit is configured to provide respective voltages for switching on and/or for switching off respective switches and/or the dead time voltage on the basis of voltage-controlled branches that are switched by corresponding transistors and/or on the basis of current-controlled branches.

Furthermore, according to an example embodiment of the present invention, it is possible that the driver unit is configured to provide the dead time voltage on the basis of a Zener diode. For example, the dead time voltage can advantageously be derived from the voltage provided to switch off the first switch and/or the second switch outside the dead time by using the Zener diode.

In a further advantageous embodiment of the present invention, the driver unit is configured to autonomously provide the dead time voltage in response to receiving a control signal for switching on and/or switching off from the control unit. In other words, the driver unit is configured to receive only signals for switching on and switching off from the control unit and to generate the dead time voltage provided for the dead time itself in response to these signals and/or to apply it to the gate of the relevant switch. For this purpose, for example, suitable delay elements can be provided in the driver unit, on the basis of which the dead time voltage is automatically switched to a voltage deviating from the dead time voltage after a predefined time in order to apply a regular switch-on voltage or a regular switch-off voltage to the gate of the relevant switch. Alternatively or additionally, the driver unit is configured to provide the dead time voltage in response to receiving a control signal for providing the dead time voltage from the control unit. In this case, the control unit accordingly specifies all gate voltages itself.

According to a second aspect of the present invention, an electrical system is proposed having a circuit arrangement according to the first aspect of the present invention and a DC voltage source, wherein the DC voltage source is configured to provide a DC voltage to the circuit arrangement and wherein the circuit arrangement is configured to generate an AC voltage on the basis of the DC voltage and to operate the load by means of the AC voltage. The features, combinations of features and the advantages resulting therefrom correspond to those discussed in connection with the first-mentioned aspect of the present invention, such that reference is made to the above statements in order to avoid repetitions.

### BRIEF DESCRIPTION OF THE DRAWINGS

In the following, exemplary embodiments of the present invention are described in detail with reference to the figures.

FIG. 1 is a circuit diagram of an exemplary embodiment of an electrical system according to the present invention with a circuit arrangement according to an example embodiment of the present invention.

FIG. 2 shows by way of example signal curves within the circuit arrangement according to an example embodiment of the present invention.

### DETAILED DESCRIPTION OF EXAMPLE EMBODIMENTS

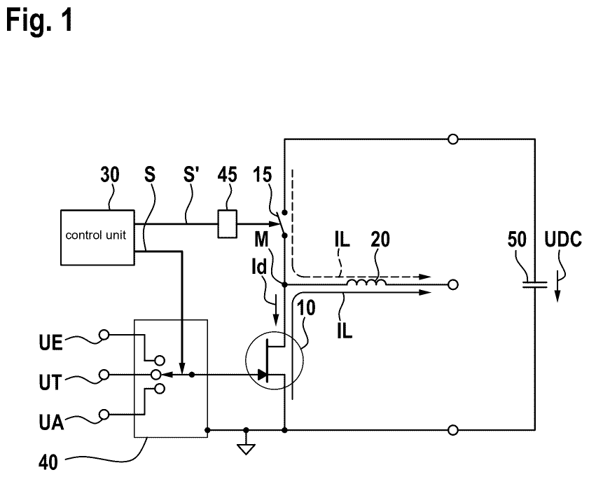

FIG. 1 is a circuit diagram of an exemplary embodiment of an electrical system according to the present invention with a circuit arrangement according to the present invention for reducing dead time losses of an inverter.

The circuit arrangement has a half-bridge arrangement consisting of a first switch 10 and a second switch 15. For the sake of a simplified representation, only the first switch 10 is designed as an n-channel junction field effect transistor here by way of example, wherein the second switch 15 can advantageously also be designed as a junction field effect transistor. The control according to the present invention described below for the first switch 10 can therefore also be implemented for the second switch 15, as will be readily apparent to a person skilled in the art in view of the disclosure herein.

An inductive load 20, through which a load current IL flows, is arranged at a center point M of the half-bridge arrangement. The circuit arrangement according to the present invention further has a control unit 30 designed as a microcontroller; a first driver unit 40; and a second driver unit 45, wherein the second driver unit 45 is provided for the second switch 15 and is configured to control the second switch 15 on the basis of a second control signal S′ provided by the circuit unit 30. If the second switch 15 is designed as a junction field effect transistor, the second driver unit 45 can preferably be designed analogously to the first driver unit 40.

In this case, the half-bridge arrangement is electrically connected to an intermediate circuit capacitor 50 that substantially behaves like a DC voltage source.

By means of a complementary control of the first switch 10 and the second switch 15 by the control unit 30, the half-bridge arrangement is configured to provide the load 20 with an AC voltage based on a voltage UDC of the intermediate circuit capacitor 50.

The control unit 30 is configured to maintain a dead time between the complementary switching of the first switch 10 and the second switch 15 on the basis of a first control signal S and the second control signal S′ in order to prevent a short circuit of the intermediate circuit capacitor 50.

The first driver unit 40 is configured, on the basis of a control by the control unit 30, to provide a gate of the first switch 10 with a dead time voltage UT during a switch-on process and/or during a switch-off process of the first switch 10 during the dead time, which dead time voltage is less than a threshold voltage of the first switch 10 and greater than a switch-off voltage UA provided for blocking the first switch 10 outside the dead time.

In addition, the first driver unit 40 is configured to provide a switch-on voltage UE in response to a control by the control unit 30 in order to switch on the first switch 10.

In this case, the dead time voltage UT provided by the first driver unit 40 corresponds, for example, to a value of −13 V, while the switch-on voltage UE corresponds, for example, to a value of 0 V and the switch-off voltage corresponds, for example, to a value of −20 V.

Advantageously, the circuit arrangement is configured to dynamically adapt the dead time voltage UT depending on present boundary conditions in order to always achieve an optimal reduction of dead time losses while simultaneously ensuring an off state of the first switch 10 during the dead time phases.

Further advantageously, the first driver unit 40 is configured to provide the dead time voltage UT by means of a Zener diode (not shown) on the basis of the switch-off voltage UA.

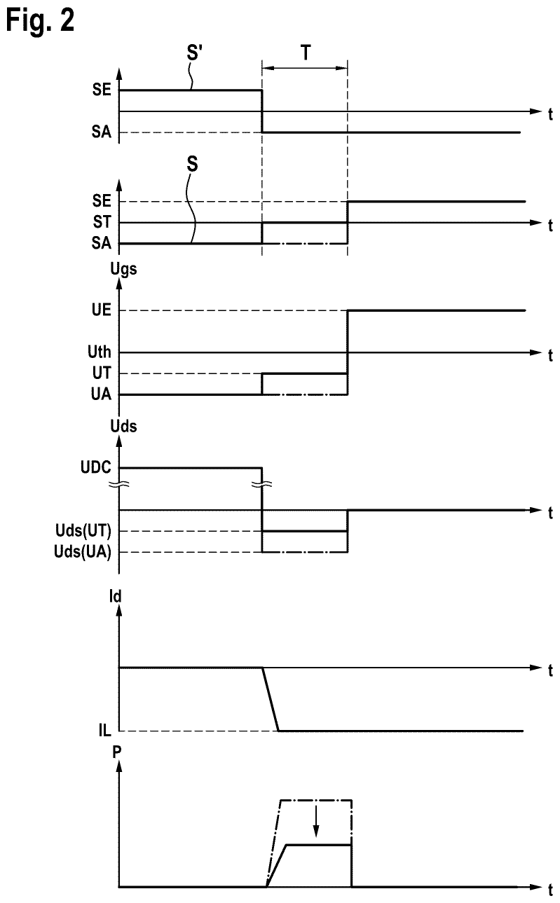

FIG. 2 shows by way of example signal curves within the circuit arrangement according to the present invention during a switch-off process of the first switch 10 shown in FIG. 1, wherein the respective horizontal axes of the diagrams represent a time t.

The top diagram in FIG. 2 shows a second signal S′, on the basis of which the second switch 15 shown in FIG. 1 is controlled. The second signal S′ has a signal state SE when the second switch 15 is to be switched on or left in the switched on state, and it has a signal state SA when the second switch 15 is to be switched off or left in the switched off state. Furthermore, this diagram indicates the dead time required between the complementary switching of the first switch 10 (see FIG. 1) and the second switch 15.

The second diagram from the top in FIG. 2 shows respective signal states SE, ST, SA of a first signal S, on the basis of which the first switch 10 is controlled. The signal states SE and SA correspond to the states in the first diagram, while the additional state ST is provided for activating the dead time voltage UT described in FIG. 1.

The third diagram from the top in FIG. 2 shows gate voltages Ugs generated by the first driver unit 40 described in FIG. 1, which gate voltages can assume the voltage values UE (switch-on voltage), UT (dead time voltage), UA (switch-off voltage) for controlling the gate of the first switch 10. Furthermore, the threshold voltage Uth of the first switch 10 is shown.

The fourth diagram from the top in FIG. 2 shows the drain-source voltages of the first switch 10 corresponding to the control voltages UE, UT, UA.

The fifth diagram from the top in FIG. 2 shows the drain current Id flowing through the first switch 10.

The bottom diagram in FIG. 2 shows the reduced power loss (solid line) achieved by the control according to the present invention during the dead time phase T in comparison with the power loss (dashed-dotted line) due to a conventional control.

It should be noted in general that the respective signal curves shown in FIG. 2 can represent a switch-on process of the first switch 10, preferably in time-mirrored form.

1-10. (canceled)

11. A circuit arrangement for reducing dead time losses of an inverter, comprising:
a half-bridge arrangement including a first switch and a second switch;
a load;
a control unit; and
a driver unit;
wherein
at least the first switch is a junction field effect transistor,
the load is connected to a center point of the half-bridge arrangement and is at least partially an inductive load,
the half-bridge arrangement is configured to be connected to a DC voltage source and to provide an AC voltage to the load using a complementary control of the first switch and the second switch by the control unit based on a voltage of the DC voltage source,
the control unit is configured to maintain a dead time between the complementary switching of the first switch and the second switch to prevent a short circuit of the DC voltage source, and
the driver unit is configured, based on a control by the control unit, to provide a gate of the first switch with a dead time voltage during a switch-on process and/or during a switch-off process of the first switch during the dead time, the dead time voltage being smaller than a threshold voltage of the first switch and greater than a voltage provided for blocking the first switch outside the dead time.

12. The circuit arrangement according to claim 11, wherein the dead time voltage is a voltage that is below the threshold voltage while maintaining a required predefined tolerance as close as possible to the threshold voltage of the first switch.

13. The circuit arrangement according to claim 11, wherein the dead time voltage is between −11.5 V and −19.5 V.

14. The circuit arrangement according to claim 11, wherein:
the second switch is a junction field effect transistor, and
the circuit arrangement is configured to control the second switch during the dead time in a manner corresponding to the control of the first switch.

15. The circuit arrangement according to claim 11, wherein the circuit arrangement is configured to dynamically adapt the dead time voltage depending on present boundary conditions.

16. The circuit arrangement according to claim 11, wherein the circuit arrangement is configured to dynamically adapt a point in time and/or a duration of a provision of the dead time voltage within the dead time depending on present boundary conditions.

17. The circuit arrangement according to claim 11, wherein the driver unit is configured to provide respective voltages for switching on and/or for switching off respective switches of the first and second switches and/or the dead time voltage, based on:
voltage-controlled branches that are switched by corresponding transistors, and/or
current-controlled branches.

18. The circuit arrangement according to claim 11, wherein the driver unit is configured to provide the dead time voltage based on a Zener diode.

19. The circuit arrangement according to claim 11, wherein the driver unit is configured to:
autonomously provide the dead time voltage in response to receiving a control signal for switching on and/or switching off from the control unit, and/or provide the dead time voltage in response to receiving a control signal for
providing the dead time voltage from the control unit.

20. An electrical system, comprising:
a circuit arrangement for reducing dead time losses of an inverter, including:
a half-bridge arrangement including a first switch and a second switch,
a load,
a control unit, and
a driver unit,
wherein
at least the first switch is a junction field effect transistor,
the load is connected to a center point of the half-bridge arrangement and is at least partially an inductive load,
the half-bridge arrangement is configured to be connected to a DC voltage source and to provide an AC voltage to the load using a complementary control of the first switch and the second switch by the control unit based on a voltage of the DC voltage source,
the control unit is configured to maintain a dead time between the complementary switching of the first switch and the second switch to prevent a short circuit of the DC voltage source, and
the driver unit is configured, based on a control by the control unit, to provide a gate of the first switch with a dead time voltage during a switch-on process and/or during a switch-off process of the first switch during the dead time, the dead time voltage being smaller than a threshold voltage of the first switch and greater than a voltage provided
for blocking the first switch outside the dead time; and
the DC voltage source configured to provide the circuit arrangement with a DC voltage;
wherein the circuit arrangement is configured to generate the AC voltage based on the DC voltage and to operate the load using the AC voltage.
